(19) United States
(12) Patent Application Publication
(10) Pub. No.: US 2018/0039637 A1
(43) Pub. Date: Feb. 8, 2018

(54) METHOD AND SYSTEM FOR MULTIMEDIA PROCESSING TO IDENTIFY CONCEPTS IN MULTIMEDIA

(71) Applicant: YEN4KEN, INC., Princeton, NJ (US)

(72) Inventors: Ankit Gandhi, Raipur (C.G.) (IN); Arijit Biswas, Kolkata (IN); Om D. Deshmukh, Bangalore (IN); Sohil Shah, Santa Clara, CA (US); Kuldeep Kulkarni, Ilkal (IN)

(21) Appl. No.: 15/225,936

(22) Filed: Aug. 2, 2016

(51) Int. Cl. G06F 17/30; G06N 99/00; G06F 17/24

(52) U.S. Cl. CPC G06F 17/30058; G06F 17/241; G06F 17/3002; G06N 99/005

(57) ABSTRACT

The disclosed embodiments illustrate methods and systems for multimedia processing to identify concepts in multimedia content. The method includes receiving the multimedia content ant at least one annotation of multimedia content at a computing device from another computing device. The received at least one annotation includes a plurality of keywords that is representative of at least a plurality of concepts in the received multimedia content. The method further includes extracting a plurality of features from the received multimedia content by performing a statistical analysis of the multimedia content, based on the plurality of keywords in the at least one annotation. The method further includes identifying the plurality of concepts in a set of frames of the multimedia content by use of one or more classifiers. The one or more classifiers are trained, based on at the extracted plurality of features.

### TECHNICAL FIELD

The presently disclosed embodiments are related, in general, to a multimedia processing system. More particularly, the presently disclosed embodiments are related to a method and system for multimedia processing to identify concepts in multimedia content.

### BACKGROUND

Recent advancements in the fields of computer networks and information technology have led to the usage of multimedia content as a popular means of knowledge sharing. In general, various organizations upload large amounts of multimedia content on various websites for the use of multiple users. When such users watch the multimedia content they may append annotations to the multimedia content for describing certain aspects or concepts covered in the multimedia content.

However, the users may not specify the exact segment of multimedia content that corresponds to the annotations. Thus, annotating the multimedia content does not indicate a point of occurrence and/or a temporal location of the concept associated with the annotation. Therefore, an advanced mechanism, which is more efficient and extensive, is required, to enhance the relevance of appended annotations.

Further, limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method for multimedia processing to identify concepts in multimedia content. The method includes receiving, by a content extractor processor at a computing device, the multimedia content from another computing device. The received at least one annotation includes a plurality of keywords that is representative of at least a plurality of concepts in the received multimedia content. The method further includes extracting, by a feature extracting processor at the computing device, a plurality of features from the received multimedia content by performing a statistical analysis of the multimedia content, based on the plurality of keywords in the at least one annotations. The method further includes identifying, by a concept identifying processor at the computing device, the plurality of concepts in a set of frames of the multimedia content by use of the one or more classifiers. The one or more classifiers are trained, based on at least the extracted plurality of features.

According to embodiments illustrated herein, there is provided a system for multimedia processing to identify concepts in multimedia content. The system includes a content extracting processor at a computing device configured to receive the multimedia content and at least one annotation of the multimedia content from another computing device. The received at least one annotation includes a plurality of keywords that is representative of at least a plurality of concepts in the received multimedia content. The system further includes a feature extracting processor at the computing device configured to extract a plurality of features from the received multimedia content by performing a statistical analysis of the multimedia content, based on the plurality of keywords in the at least one annotation. The system further includes a concept identifying processor at the computing device configured to identify the plurality of concepts in a set of frames of the multimedia content by use of one or more classifiers. The one or more classifiers are trained, based on at least the extracted plurality of features.

According to embodiment illustrated herein, there is provided a computer program product for use with a computer. The computer program product includes a non-transitory computer readable medium. The non-transitory computer readable medium stores a computer program code for multimedia processing to identify concepts in multimedia content. The computer program code is executable by one or more processors to receive the multimedia content and at least one annotation of the multimedia content from another computing device. The received at least one annotation includes a plurality of keywords that is representative of at least a plurality of concepts in the received multimedia content. The computer program code is further executable by one or more processors to extract a plurality of features from the received multimedia content by performing a statistical analysis of the multimedia content, based on the plurality of keywords in the at least one annotation. The computer program code is further executable by one or more processors to identify the plurality of concepts in a set of frames of the multimedia content by use of one or more classifiers. The one or more classifiers are trained, based on at least the extracted plurality of features.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented, in accordance with at least one embodiment;

FIG. 2 is a block diagram that illustrates a system for multimedia processing to identify concepts in multimedia content, in accordance with at least one embodiment;

FIG. 3 is a flowchart that illustrates a method for multimedia processing to identify concepts in multimedia content, in accordance with at least one embodiment;

FIG. 4 is a block diagram that illustrates an exemplary scenario for multimedia processing to identify concepts in multimedia content, in accordance with at least one embodiment; and

FIGS. 5A and 5B are block diagrams that illustrate graphical user interface for presenting multimedia content to a requestor, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### Definitions

The following terms shall have, for the purposes of this application, the meanings set forth below.

A “requestor-computing device” refers to a computer, a device (that includes one or more processors/microcontrollers and/or any other electronic components), or a system (that performs one or more associated operations according to one or more sets of instructions, codes, programs, and/or the like). In an embodiment, the requestor-computing device may be configured to receive multimedia content and at least one annotation of the multimedia content from a user-computing device. Examples of the requestor-computing device may include, but are not limited to, a desktop computer, a laptop, a personal digital assistant (PDA), a mobile device, a smartphone, and a tablet computer (for example, iPad® and Samsung Galaxy Tab®).

A “user-computing device” refers to a computer, a device (that includes one or more processors/microcontrollers and/or any other electronic components), or a system (that performs one or more associated operations according to one or more sets of instructions, codes, programs, and/or the like). In an embodiment, the user-computing device may be configured to transmit multimedia content and at least one annotation of the multimedia content to a requestor-computing device. Examples of the second computing device may include, but are not limited to, a desktop computer, a laptop, a PDA, a mobile device, a smartphone, and a tablet computer.

“Multimedia content” refers to content that uses a combination of different content forms, such as text content, audio content, image content, animation content, video content, and a moving slideshow. In an embodiment, the multimedia content may be a combination of a set of frames. In an embodiment, the multimedia content may be associated with least one annotation. In an embodiment, the multimedia content may be reproduced on a requestor-computing device (or a user-computing device) through an application, such as a media player (for example, Windows Media Player®, Adobe® Flash Player, Microsoft Office®, Apple® QuickTime®, and the like). In an embodiment, the multimedia content may be downloaded from a server to the requestor-computing device. In another embodiment, the multimedia content and the at least one annotation may be received from the user-computing device. In yet another embodiment, the multimedia content may be retrieved from a media storage device, such as a hard disk drive (HDD), a CD drive, a pen drive, and the like, connected to (or inbuilt within) the user-computing device.

“Statistical analysis” refers to collecting, exploring, and presenting a large amount of data to discover underlining patterns and trends of multimedia content. In an embodiment, a plurality of features from the multimedia content may be extracted by performing the statistical analysis of the multimedia content.

A “set of frames” refers to a set of images that is rendered, on a display device, in succession to produce what appears to be a seamless piece of multimedia content. Each frame in the set of frames corresponds to a single picture or a still shot that is a part of a larger multimedia content (e.g., a video).

A “plurality of features” refers to plurality of feature points that are utilized to detect and/or track a person (i.e., face), an object, and/or an action in a multimedia content (e.g., a video). In an embodiment, the plurality of features may be utilized to train one or more classifiers to detect and/or track a person (i.e., face), an object, and/or an action in the multimedia content. In an embodiment, the plurality of features may be extracted from the multimedia content by use of one or more image processing algorithms, such as face detection, shot boundary detection, shot tracking, face tracking, and bounding box tracking, and non-parametric statistical analysis, such as Gaussian mixture modelling, principle component analysis, and/or the like.

An “annotation” refers to a label/tag appended with multimedia content. The annotation comprises a plurality of keywords that is representative of a plurality of concepts (i.e., a subject and/or an action) present in the multimedia content.

A “plurality of concepts” refers to at least two of an entity, an object, an action, and a scene in multimedia content. In an embodiment, a concept of the plurality of concepts is interrelated with other concepts in the plurality of concepts. For example, a concept, such as a person “A” (i.e., an instance of an entity/subject), may be interrelated with another concept, such as riding a bicycle (i.e., an instance of an action). In an embodiment, the plurality of concepts may be identified by the use of one or more trained classifiers.

“One or more classifiers” refer to mathematical models that are utilized to identify a plurality of concepts in multimedia content. In an embodiment, the plurality of classifiers may be trained based on a plurality of features extracted from another multimedia content with identified plurality of concepts. Examples of one or more techniques that may be utilized to train the one or more classifiers include, but are not limited to, Support Vector Machine (SVM), Nonparametric Bayes Model, Stacked Indian Buffet Process (SIBP), Latent Variable Model, Gaussian Mixture Model (GMM), Principal Component Analysis (PCA), Dirichlet Process Mixture Model, and/or Multi-instance Multi-label (MIML).

“One or more pre-defined constraints” correspond to one or more conditions that are utilized to train one or more classifiers to identify a plurality of concepts from multimedia content. In an embodiment, the one or more pre-defined constraints may comprise a first condition that at least one concept of the plurality of concepts is identified for at least one annotation of the multimedia content. The one or more pre-defined constraints may further comprise a second condition that the identified at least one concept should correspond to the at least one annotation associated with the multimedia content.

A “temporal location” refers to a time of occurrence of any concept in multimedia content. For example, a person “A” (i.e., an instance of a concept) appears in multimedia content at time stamps “00:00:34” and “00:00:35.” Thus, “00:00:34,” and “00:00:35” correspond to the temporal locations associated with the person “A” appearing in the multimedia content.

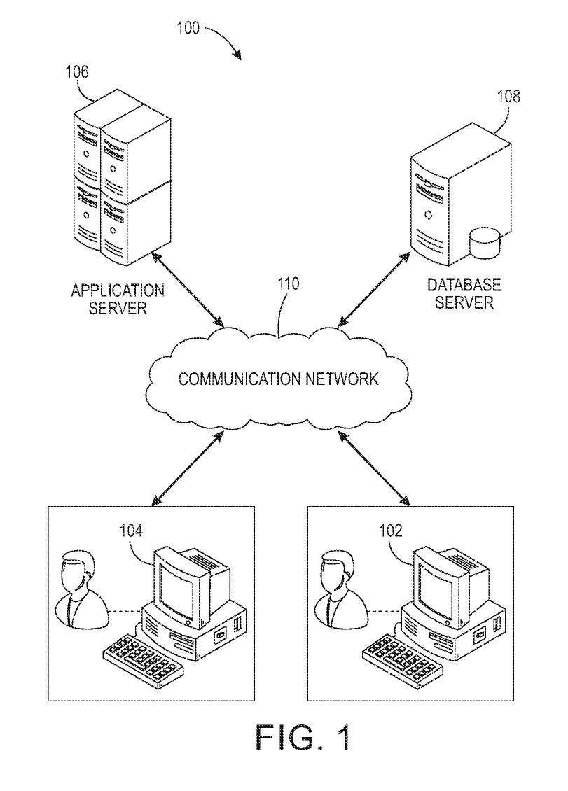

FIG. 1 is a block diagram of a system environment in which various embodiments may be implemented. With reference to FIG. 1, there is shown a system environment 100 that includes a requestor-computing device 102, a user-computing device 104, an application server 106, a database server 108, and a communication network 110. The requestor-computing device 102, the user-computing device 104, the application server 106, and the database server 108 may be communicatively coupled to each other, via the communication network 110. FIG. 1 shows, for simplicity, one requestor-computing device, such as the requestor-computing device 102, one user-computing device, such as the user-computing device 104, one application server, such as the application server 106, and one database server, such as the database server 108. However, it will be apparent to a person having ordinary skill in the art that the disclosed embodiments may also be implemented using multiple requestor-computing devices, multiple user-computing devices, multiple application servers, and multiple database servers, without departing from the scope of disclosure.

The requestor-computing device 102 may refer to a computing device (associated with a requestor) that may be communicatively coupled to the communication network 110. The requestor-computing device 102 may include one or more processors in communication with one or more memories. The one or more memories may include one or more sets of computer-readable codes, instructions, programs, and/or the like that are executable by the one or more processors to perform one or more operations. The one or more operations may include receiving multimedia content and at least one annotation of the multimedia content from the user-computing device 104, via the communication network 110. In another embodiment, the requestor may utilize the requestor-computing device 102 to retrieve the multimedia content and the at least one annotation of the multimedia content from the database server 108. In an embodiment, the at least one annotation may not be associated with any temporal location of any of a plurality of concepts in the multimedia content. Therefore, the requestor may transmit a request, by utilizing the requestor-computing device 102, to the application server 106 to identify the plurality of concepts in the multimedia content and further associate the annotation with the temporal location of at least one concept of the plurality of concepts. In an embodiment, the request may comprise the multimedia content and the at least one annotation. The requestor-computing device 102 may be further configured to receive annotated multimedia content with the identified plurality of concepts from the application server 106.

Examples of the requestor-computing device 102 may include, but are not limited to, a personal computer, a laptop, a smartphone, a PDA, a mobile device, a smartphone, and a tablet computer.

A person having ordinary skill in the art will understand that the scope of the disclosure is not limited to the utilization of the requestor-computing device 102 by a single requestor. In an embodiment, the requestor-computing device 102 may be utilized by more than one requestors to transmit the multimedia content to the application server 106.

The user-computing device 104 may refer to a computing device (associated with a user) that may be communicatively coupled to the communication network 110. The user-computing device 104 may include one or more processors in communication with one or more memories. The one or more memories may include one or more sets of computer-readable codes, instructions, programs, and/or the like that are executable by the one or more processors to perform one or more operations. In an embodiment, the one or more operations may include transmitting the multimedia content and the at least one annotation of the multimedia content to the requestor-computing device 102 or the database server 108, via the communication network 110. Prior to the transmission of the multimedia content, the user may utilize the user-computing device 104 to annotate the multimedia content with the at least one annotation. In an embodiment, the multimedia content comprises a set of frames. Further, the at least one annotation may include a plurality of keywords that is representative of at least a plurality of concepts in the multimedia content.

Examples of the user-computing device 104, may include, but are not limited to, a personal computer, a laptop, a PDA, a mobile device, a smartphone, and a tablet computer.

The application server 106 may refer to a computing device or a software framework hosting an application or a software service. In an embodiment, the application server 106 may be implemented to execute procedures, such as, but not limited to, the one or more sets of programs, instructions, codes, routines, or scripts stored in one or more memories for supporting the hosted application or the software service. In an embodiment, the hosted application or the software service may be configured to perform one or more predetermined operations. The one or more predetermined operations may include the identification of the plurality of concepts in the multimedia content.

In an embodiment, the application server 106 may be configured to receive the multimedia content and the at least one annotation of the multimedia content (i.e., the request) from the requestor-computing device 102. The application server 106 may extract the plurality of keywords from the at least one annotation. Further, the application server 106 may be configured to identify the set of frames in the multimedia content. The application server 106 may be further configured to extract a plurality of features from the multimedia content based on the plurality of keywords in the at least one annotation. In an embodiment, the application server 106 may perform a statistical analysis of the multimedia content for the extraction of the plurality of features. In an embodiment, the application server 106 may utilize one or more statistical analysis techniques known in the art, such as Gaussian mixture modelling (GMM) technique, Principle component analysis (PCA) technique, and/or the like, for the extraction of the plurality of features from the multimedia content. In an embodiment, the application server 106 may further utilize one or more image processing algorithms known in the art for the extraction of the plurality of features.

Further, the application server 106 may be configured to utilize the plurality of features for the identification of the plurality of concepts from the identified set of frames of the multimedia content. In an embodiment, the application server 106 may utilize one or more classifiers for the identification of the plurality of concepts. In an embodiment, the application server 106 may be further configured to train the one or more classifiers based on the plurality of features. In an embodiment, the one or more classifiers may correspond to one or more of a Support Vector Machine (SVM), a Nonparametric Bayes Model, a Stacked Indian Buffet Process (SIBP), a Latent Variable Model, a GMM, a PCA, a Dirichlet Process Mixture Model, and/or a Multi-instance Multi-label (MIML).

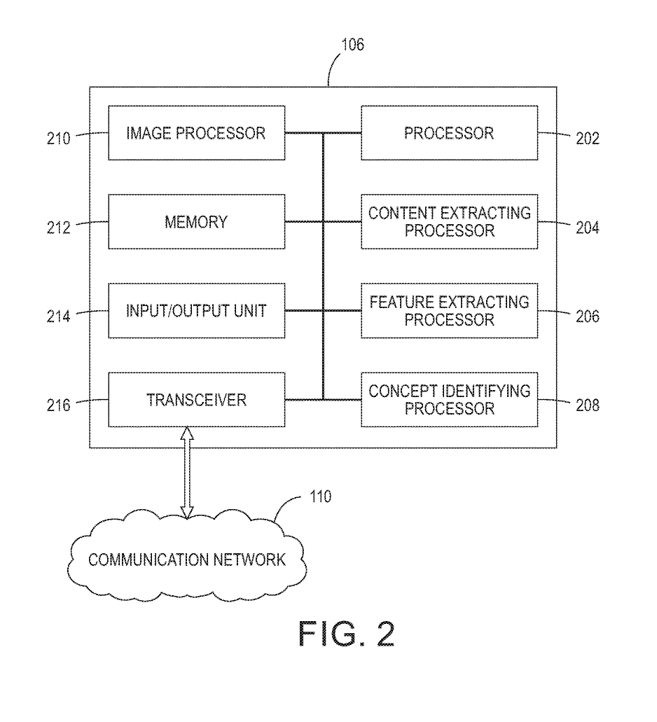

In an embodiment, the application server 106 may be further configured to associate the at least one annotation with a temporal location of at least one concept of the plurality of concepts in the multimedia content. An embodiment of the structure of the application server 106 has been discussed later in FIG. 2.

The application server 106 may be realized through various types of application servers such as, but not limited to, a Java application server, a .NET framework application server, a Base4 application server, a PHP framework application server, or any other application server framework.

A person having ordinary skill in the art will appreciate that the scope of the disclosure is not limited to realizing the application server 106, the requestor-computing device 102, and the user-computing device 104 as separate entities. In an embodiment, the application server 106 may be realized as an application program installed on, and/or running on, the requestor-computing device 102 and the user-computing device 104, without departing from the scope of the disclosure.

The database server 108 may refer to a computing device or a storage device that may be communicatively coupled to the communication network 110. In an embodiment, the database server 108 may be configured to perform one or more database operations. In an embodiment, the database server 108 may be configured to store the multimedia content and at least one annotation of the multimedia content received from the user-computing device 104. The database server 108 may be further configured to store the plurality of features extracted from the multimedia content. Further, in an embodiment, the database server 108 may store one or more sets of instructions, codes, scripts, or programs that may be retrieved by the application server 106 to perform the one or more predetermined operations. For querying the database server 108, one or more querying languages may be utilized, such as, but not limited to, SQL, QUEL, and DMX. In an embodiment, the database server 108 may be realized through various technologies such as, but not limited to, Microsoft® SQL Server, Oracle®, IBM DB2®, Microsoft Access®, PostgreSQL®, MySQL®, SQLite®, and/or the like. In an embodiment, the database server 108 communicates with the application server 106 using one or more protocols such as, but not limited to, Open Database Connectivity (ODBC) and Java Database Connectivity (JDBC).

A person having ordinary skill in the art will understand that the scope of the disclosure is not limited to realizing the database server 108 and the application server 106 as separate entities. In an embodiment, the functionalities of the database server 108 may be integrated into the application server 106, and vice versa, without deviating from the scope of the disclosure.

The communication network 110 may correspond to a communication medium through which the requestor-computing device 102, the user-computing device 104, the application server 106, and the database server 108 may communicate with each other. In an embodiment, a communication is performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), Light Fidelity (Li-Fi), ZigBee, EDGE, infrared (IR), IEEE 802.11, 802.16, 2G, 3G, 4G cellular communication protocols, and/or Bluetooth (BT) communication protocols. The communication network 110 includes, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

FIG. 2 is a diagram that illustrates a system for multimedia processing to identify concepts in multimedia content, in accordance with at least one embodiment. In an embodiment, the system may correspond to the application server 106. FIG. 2 is explained in conjunction with the elements from FIG. 1. With reference to FIG. 2, there is shown the application server 106 that may include one or more processors, such as a processor 202, one or more content extracting processors, such as a content extracting processor 204, one or more feature extracting processor, such as a feature extracting processor 206, one or more concept identifying processor, such as a concept identifying processor 208, one or more image processors, such as image processor 210, one or more memories, such as a memory 212, one or more input/output (I/O) units, such as an I/O unit 214, and one or more transceivers, such as a transceiver 216. The processor 202, the content extracting processor 204, the feature extracting processor 206, the concept identifying processor 208, the image processor 210, the memory 212, the I/O unit 214, and the transceiver 216 may be communicatively coupled to each other.

The processor 202 may comprise one or more suitable logics, circuitries, interfaces, and/or codes that may be configured to execute one or more set of instructions, programs, or algorithms stored in the memory 212 to perform one or more operations. For example, the processor 202 may be configured to process the multimedia content for the identification of the plurality of concepts in the multimedia content. In an embodiment, the processor 202 may be configured to identify the set of frames from the multimedia content. The processor 202 may be further configured to identify temporal locations associated with each of the plurality of concepts. In an embodiment, the processor 202 may be configured to annotate the multimedia content with the at least one annotation based on the plurality of the concepts. The processor 202 may be implemented based on a number of processor technologies known in the art. Examples of the processor 202 may include, but not limited to, an X86-based processor, a Reduced Instruction Set Computing (RISC) processor, an Application-Specific Integrated Circuit (ASIC) processor, a Complex Instruction Set Computing (CISC) processor, and/or other such processors.

The content extracting processor 204 may comprise one or more suitable logics, circuitries, interfaces, and/or codes that are configured to execute one or more instructions stored in the memory 212. In an embodiment, the content extracting processor 204 may be configured to extract the plurality of keywords from the at least one annotation associated with the multimedia content. Further, the content extracting processor 204 may perform one or more natural language processing operations, such as semantic analysis, on the at least one annotation. The content extraction processor 204 may be communicatively coupled with the processor 202, the feature extracting processor 206, the concept identifying processor 208, the image processor 210, the memory 212, the I/O unit 214, and the transceiver 216. Examples of the content extracting processor 204 may include, but not limited to, an X86-based processor, a RISC processor, an ASIC processor, a CISC processor, and/or other such processors.

The feature extracting processor 206 may comprise one or more suitable logics, circuitries, interfaces, and/or codes that may be configured to execute the one or more sets of instructions stored in the memory 212. In an embodiment, the feature extracting processor 206 may be configured to extract the plurality of features from the multimedia content. The feature extracting processor 206 may be configured to perform the statistical analysis of the multimedia content based on the plurality of keywords for the extraction of the plurality of features. The feature extracting processor 206 may be communicatively coupled with the processor 202, the content extracting processor 204, the concept identifying processor 208, the image processor 210, the memory 212, the I/O unit 214, and the transceiver 216. Examples of the feature extracting processor 206 may include, but not limited to, an X86-based processor, a RISC processor, an ASIC processor, a CISC processor, and/or other such processors.

The concept identifying processor 208 may comprise one or more suitable logics, circuitries, interfaces, and/or codes that may be configured to execute the one or more sets of instructions stored in the memory 212. In an embodiment, the concept identifying processor 208 may be configured to identify the plurality of concepts in the set of frames of the multimedia content. The concept identifying processor 208 may utilize the plurality of features and the one or more classifiers to identify the plurality of concepts. Examples of the one or more classifiers may include, but are not limited to, an SVM, a Nonparametric Bayes Model, an SIBP, a Latent Variable Model, a GMM, a PCA, a Dirichlet Process Mixture Model, and/or a MIML. The concept identifying processor 208 may be communicatively coupled with the processor 202, the content extracting processor 204, the feature extracting processor 206, the image processor 210, the memory 212, the I/O unit 214, and the transceiver 216. Examples of the concept identifying processor 208 may include, but not limited to, an X86-based processor, a RISC processor, an ASIC processor, a CISC processor, and/or other such processors.

The image processor 210 may comprise one or more suitable logics, circuitries, interfaces, and/or codes that may be configured to execute the one or more sets of instructions stored in the memory 212. In an embodiment, the image processor 210 may be configured to process the multimedia content for the extraction of the plurality of features. In an embodiment, the image processor 210 may utilize one or more image processing algorithms known in the art for the extraction of the plurality of features. Examples of the one or more image processing algorithms may include, but are not limited to, face detection, shot boundary detection, shot tracking, face tracking, and bounding box tracking.

A person having ordinary skill in the art will appreciate that the scope of the disclosure is not limited to realizing the processor 202, the content extracting processor 204, the feature extracting processor 206, the concept identifying processor 208, and the image processor 210 as separate entities. In an embodiment, the functionalities of the content extracting processor 204, the feature extracting processor 206, the concept identifying processor 208, and the image processor 210 may be implemented within the processor 202, without departing from the spirit of the disclosure. Further, a person skilled in the art will understand that the scope of the disclosure is not limited to realizing the content extracting processor 204, the feature extracting processor 206, the concept identifying processor 208, and the image processor 210 as hardware components. In an embodiment, the content extracting processor 204, the feature extracting processor 206, the concept identifying processor 208, and the image processor 210 may be implemented as software modules included in computer program code (stored in the memory 212), which may be executable by the processor 202 to perform the functionalities of the content extracting processor 204, the feature extracting processor 206, the concept identifying processor 208, and the image processor 210.

The memory 212 may comprise one or more suitable logics, circuitries, interfaces, and/or codes that may be configured to store the one or more set of instructions, programs, or algorithms, which are executed by the processor 202 to perform the one or more predetermined operations. In an embodiment, the memory 212 may be configured to store one or more programs, routines, or scripts that may be executed in coordination with the processor 202, the content extracting processor 204, the feature extracting processor 206, the concept identifying processor 208, and the image processor 210. The memory 212 may be implemented based on a Random Access Memory (RAM), a Read-Only Memory (ROM), a Hard Disk Drive (HDD), a storage server, and/or a Secure Digital (SD) card. It will be apparent to a person having ordinary skill in the art that the one or more sets of instructions, codes, scripts, and programs stored in the memory 212 may enable the hardware of the system (the application server 106) to perform the one or more predetermined operations.

The I/O unit 214 may comprise suitable logic, circuitry, interfaces, and/or code that may be configured to provide an output to the user and/or the service provider. The I/O unit 214 comprises various input and output devices that are configured to communicate with the processor 202. Examples of the input devices may include, but are not limited to, a keyboard, a mouse, a joystick, a touch screen, a microphone, a camera, and/or a docking station. Examples of the output devices include, but are not limited to, a display screen and/or a speaker.

The transceiver 216 may comprise one or more suitable logics, circuitries, interfaces, and/or codes that may be configured to receive or transmit the one or more queries, data, content, or other information to/from one or more computing devices (e.g., the requestor-computing device 102, the user-computing device 104, and the database server 108) over the communication network 110. In an embodiment, the transceiver 216 may be configured to receive a request from the requestor-computing device 102 for the identification of the plurality of concepts. The request may comprise the multimedia content and the at least one annotation. The transceiver 216 may implement one or more known technologies to support wired or wireless communication with the communication network 110. In an embodiment, the transceiver 216 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 216 may communicate via wireless communication with networks, such as the Internet, an Intranet and/or a wireless network, such as a cellular telephone network, a wireless local area network (LAN) and/or a metropolitan area network (MAN). Examples of the transceiver 216 may include, but are not limited to, an antenna, an Ethernet port, a USB port, or any other port configured to receive and transmit data.

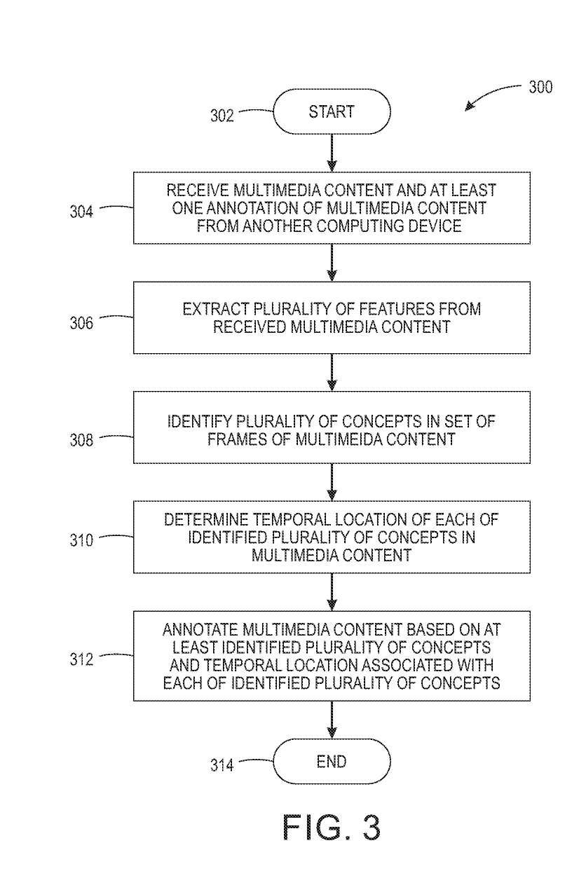

FIG. 3 is a flowchart that illustrates a method for multimedia processing to identify concepts in multimedia content, in accordance with at least one embodiment. FIG. 3 is described in conjunction with elements from FIG. 1 and FIG. 2. With reference to FIG. 3, there is shown a flowchart 300 that illustrates the method for multimedia processing to identify the plurality of concepts in the multimedia content. The method starts at step 302 and proceeds to step 304.

At step 304, the multimedia content and the at least one annotation of the multimedia content is received from the requestor-computing device 102. In an embodiment, the processor 202, in conjunction with the transceiver 216 may be configured to receive the multimedia content and the at least one annotation of the multimedia content from the requestor-computing device 102. In an embodiment, the processor 202, in conjunction with the transceiver 216, may receive the request from the requestor-computing device 102 for the identification of the plurality of concepts. The request may further comprise the multimedia content and the at least one annotation of the multimedia content. In an embodiment, the received multimedia content may correspond to at least one of video, audio, and/or moving slideshow. Further, the at least one annotation associated with the multimedia content may comprise the plurality of keywords.

For example, the processor 202 may receive multimedia content such as “a training module for outdoor sports.” Further, the received multimedia content may be associated with an annotation such as “a person riding a bicycle.”

Prior to the reception of the multimedia content and the at least one annotation, the requestor associated with the requestor-computing device 102 may have received the multimedia content and the at least one annotation from the user-computing device 104. In another embodiment, the requestor may have utilized the requestor-computing device 102 to retrieve the multimedia content and the at least one annotation from the database server 108.

After the reception of the multimedia content, the processor 202 may be configured to identify the set of frames in the multimedia content by utilizing one or more video processing techniques known in the art. Thereafter, the content extracting processor 204, in conjunction with the processor 202, may be configured to extract the plurality of keywords from the at least one annotation associated with the multimedia content. In an embodiment, the content extracting processor 204 may utilize one or more text processing algorithms, such as optical character recognition, for the extraction of the plurality of keywords from the at least one annotation. In another embodiment, the content extracting processor 204 may be configured to remove one or more stop words, such as interjections, prepositions, articles, and/or the like, from the extracted plurality of keywords.

In an exemplary implementation, the content extracting processor 204 may extract the plurality of keywords, such as “a,” “person,” “riding,” and “bicycle” from the annotation, such as “a person riding a bicycle.” The content extracting processor 204 may further remove one or more stop words, such as “a,” from the plurality of keywords.

A person having ordinary skill in the art will understand that the abovementioned example is for illustrative purpose and should not be construed to limit the scope of the disclosure.

At step 306, the plurality of features is extracted from the received multimedia content. In an embodiment, the feature extracting processor 206, in conjunction with the image processor 210, may be configured to extract the plurality of features from the received multimedia content. In an embodiment, the feature extracting processor 206 may utilize a non-parametric method to perform the statistical analysis of the multimedia content for the extraction of the plurality of features. Further, the image processor 210 may process the multimedia content by utilizing one or more image processing algorithms known in the art for the extraction of the plurality of features. Examples of the one or more image processing algorithms may include, but are not limited to, face detection, shot boundary detection, shot tracking, face tracking, bounding box tracking, and activity detection. In an embodiment, the plurality of features may correspond to one or more feature points associated with one or more faces in the multimedia content, one or more feature points associated with one or more objects in the multimedia content, and one or more feature points associated with one or more actions in the multimedia content.

In a scenario, the feature extracting processor 206, in conjunction with the image processor 210, may utilize the plurality of keywords, such as “person,” “riding,” and “bicycle,” to extract the plurality of features from the multimedia content. The feature extracting processor 206 may extract the one or more feature points associated with the one or more faces in the multimedia content because of the presence of extracted keyword “person” in the plurality of the keywords. Further, the feature extracting processor 206 may extract the one or more feature points associated with the one or more actions in the multimedia content due to the presence of extracted keyword “riding” in the plurality of the keywords. Further, the feature extracting processor 206 may extract the one or more feature points associated with the one or more objects from the multimedia content because of the presence of extracted keyword “bicycle” in the plurality of the keywords.

A person having ordinary skill in the art will understand that the scope of the disclosure is not limited to include the one or more feature points, associated with the one or more faces, objects, and actions in the plurality of features. In an embodiment, the plurality of features may include any statistical feature values that may be utilized by the one or more classifiers.

At step 308, the plurality of concepts is identified in the set of frames of the multimedia content. In an embodiment, the concept identifying processor 208, in conjunction with the processor 202, may be configured to identify the plurality of concepts in the set of frames of the multimedia content. In an embodiment, the plurality of concepts may include at least two of an entity, an object, an action, and a scene. In an embodiment, the concept identifying processor 208 may utilize the extracted plurality of features to identify the plurality of concepts from the set of frames of the multimedia content by use of the one or more classifiers. In an embodiment, the one or more classifiers may correspond to a Support Vector Machine (SVM), a Nonparametric Bayes Model, a Stacked Indian Buffet Process (SIBP), a Latent Variable Model, a Gaussian Mixture Model (GMM), a Principal Component Analysis (PCA), a Dirichlet Process Mixture Model, and/or a Multi-instance Multi-label (MIML).

Prior to the extraction of the plurality of concepts, the concept identifying processor 208, in conjunction with the processor 202, may be configured to train the one or more classifiers to extract the plurality of concepts. In an embodiment, the processor 202 may train the one or more classifiers based on the plurality of features extracted from other multimedia content with the identified plurality of concepts. In an embodiment, the other multimedia content may be annotated with the plurality of concepts by one or more human subjects, via a crowd-sourcing platform. In an embodiment, the one or more classifiers are further trained by the processor 202, based on one or more pre-defined constraints. In an embodiment, the one or more pre-defined constraints comprise a first condition that the processor 202 is configured to identify at least one concept, of the plurality of concepts, for the at least one annotation. The one or more pre-defined constraints further comprise a second condition that the identified at least one concept of the plurality of concepts should correspond to the at least one annotation. In an embodiment, the one or more pre-defined constraints further comprises one or more pre-specified constants.

After the training, the one or more classifiers may be utilized to identify the plurality of concepts. Examples of the plurality of concepts may include, but are not limited to, one or more faces (i.e., an instance of an entity), one or more objects, one or more actions, one or more shot boundaries, and one or more subset of frames with similar faces, actions, and/or objects (i.e., an instance of a scene) from the set of frames of the multimedia content.

In a scenario, the one or more classifiers may identify the one or more faces in the multimedia content based on the extracted one or more feature points associated with the one or more faces in the multimedia content. Further, the one or more classifiers may identify the one or more actions (e.g., playing, running, moving, riding, and/or the like) in the multimedia content based on the extracted one or more feature points associated with the one or more actions in the multimedia content. Further, the one or more classifiers may identify the one or more objects (e.g., football, bicycle, and/or the like) in the multimedia content based on the extracted one or more feature points associated with the one or more objects in the multimedia content. The extracted one or more faces, actions, and objects may correspond to the plurality of concepts.

In another scenario, the one or more classifiers may identify the one or more subset of frames that comprises a similar face, action, and/or object. The one or more subset of frames associated with the similar face or object may correspond to a subject track and the one or more subset of frames associated with the similar action may correspond to an action track. The extracted subject track and the action track may further correspond to the plurality of concepts.

A person having ordinary skill in the art will understand that the abovementioned scenarios are for illustrative purpose and should not be construed to limit the scope of the disclosure.

At step 310, a temporal location of each of the identified plurality of concepts in the multimedia content is determined. In an embodiment, the processor 202 may be configured to determine the temporal location of each of the identified plurality of concepts in the multimedia content. In an embodiment, the processor 202 may determine the temporal location of each of the identified plurality of concepts based on the identified set of frames of the multimedia content. The processor 202 may identify the occurrence of the plurality of concepts in the set of frames.

For instance, the face of a person “A” (i.e., an instance of a concept) appears in the 11^{th}, 12^{th}, 13^{th}, and 14^{th} frames of the multimedia content. Further, the 10^{th}, 11^{th}, 12^{th}, 13^{th}, and 14^{th} frames have the temporal locations “00:00:24,” “00:00:25,” “00:00:26,” and “00:00:27,” respectively. Thus, the processor 202 may identify the temporal locations “00:00:24,” “00:00:25,” “00:00:26,” and “00:00:27” for the face of the person “A.” In another instance, an action, such as bicycle riding (i.e., another instance of a concept), may appear in the 11^{th}, 12^{th}, 13^{th}, and 14^{th} frames of the multimedia content. Further, the 11^{th}, 12^{th}, 13^{th}, and 14^{th} frames have the temporal locations “00:00:24,” “00:00:25,” “00:00:26,” and “00:00:27,” respectively. Thus, the processor 202 may identify the temporal locations “00:00:24,” “00:00:25,” “00:00:26,” and “00:00:27” for the action, such as bicycle riding.

In an embodiment, the processor 202 may be further configured to identify a time interval associated with the subject track and/or the action track in the multimedia content. For example, the processor 202 may identify a time interval, such as “00:00:56-00:01:53,” for a subject track, such as a subset of frames associated with the face of a person “B.” The processor 202 may further identify a time interval, such as “00:00:56-00:01:47,” for an action track, such as a subset of frames associated with an action “swimming.”

A person having ordinary skill in the art will understand that the abovementioned exemplary scenarios are for illustrative purpose and should not be construed to limit the scope of the disclosure.

After the identification of the temporal locations, in an embodiment, the processor 202 may be configured to interrelate the identified plurality of concepts. In an embodiment, the processor 202 may utilize the identified temporal locations for interrelating the identified plurality of concepts. In a scenario, the processor 202 may interrelate the face of a person “A” (i.e., an instance of a concept) that is associated with the temporal locations “00:00:24,” “00:00:25,” “00:00:26,” and “00:00:27” with bicycle riding, that is associated with the temporal locations “00:00:24,” “00:00:25,” “00:00:26,” and “00:00:27.” In another scenario, the processor 202 may interrelate the subset of frames associated with the face of a person “B” (i.e., another instance of a concept) appearing at the time interval “00:00:56-00:01:53,” with the subset of frames associated with swimming (i.e., another instance of a concept) appearing at the time interval “00:00:56-00:01:47.” Thus, the processor 202 may interrelate the identified plurality of concepts based on a similarity between the corresponding temporal locations and/or the time intervals.

A person having ordinary skill in the art will understand that the scope of the disclosure is not limited to interrelating the identified plurality of concepts when the corresponding temporal locations and/or the time intervals are same. In another embodiment, the processor 202 may interrelate any two concepts when the difference between the corresponding temporal locations and/or the time intervals is less than a pre-specified threshold.

At step 312, the multimedia content is annotated, based on at least the identified plurality of concepts and the temporal location associated with each of the identified plurality of concepts. In an embodiment, the processor 202 may be configured to annotate the multimedia content based on at least the identified plurality of concepts and the temporal location associated with each of the identified plurality of concepts. The processor 202 may utilize one or more processes, such as the Indian Buffet Process (IBP), known in the art for annotation.

For the annotation, the processor 202 may be configured to identify the interrelated concepts that correspond to the at least one annotation. For example, an annotation, such as “a person riding a bicycle,” may be associated with the interrelated concepts, such as the face of a person “A” and bicycle riding. In an embodiment, the content extracting processor 204 may be configured perform one or more natural language processing operations, such as semantic analysis, on the at least one annotation for the identification of an interrelated concept of the plurality of concepts that is represented by the plurality of keywords in the at least one annotation. For example, the processor 202 may identify interrelated concepts, such as a face of a person “A” and riding bicycle, for an annotation with the plurality of keywords, such as “person,” “riding,” and “bicycle.”

After the identification of the interrelated concepts for the at least one annotation, the processor 202 may annotate the multimedia content at the temporal location of the interrelated concept associated with the annotation. For example, the processor 202 may annotate the temporal locations, such as “00:00:24,” “00:00:25,” “00:00:26,” and “00:00:27,” of two interrelated concepts, such as a face of a person “A” and “riding bicycle,” with the annotation such as “a person riding a bicycle.”

A person having ordinary skill in the art will understand that the abovementioned example is for illustrative purpose and should not be construed to limit the scope of the disclosure.

After the annotation of the multimedia content, the processor 202, in conjunction with the transceiver 216, may be configured to transmit the annotated multimedia content to the requestor-computing device 102, over the communication network 110. Further, the requestor may utilize the annotated multimedia content to directly view the portion of the multimedia content that is associated with the at least one annotation. In an embodiment, the processor 202 may be further configured to store the annotated multimedia content in the database server 108 over the communication network 110. The control passes to end step 314.

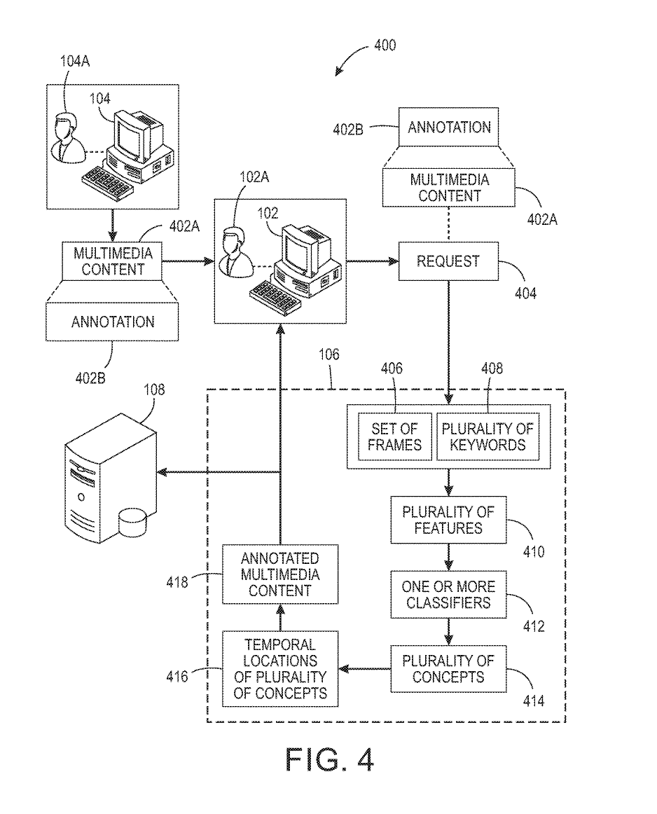

FIG. 4 is a block diagram that illustrates an exemplary scenario for multimedia processing to identify concepts in multimedia content, in accordance with at least one embodiment. FIG. 4 is described in conjunction with FIGS. 1-3. With reference to FIG. 4, there is shown an exemplary scenario 400 that illustrates the method for multimedia processing to identify the plurality of concepts in multimedia content.

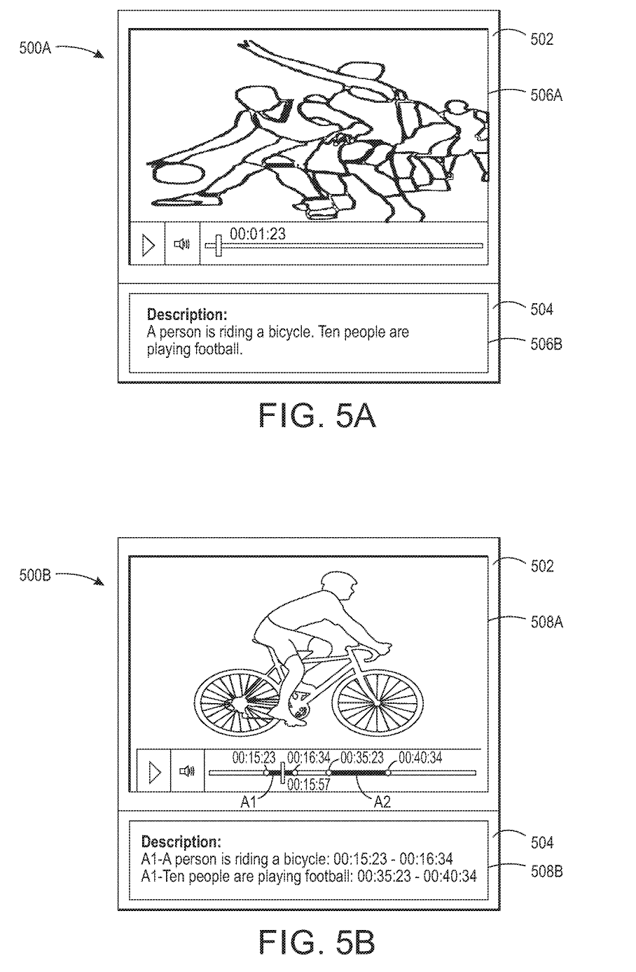

With reference to FIG. 4, there is shown the requestor-computing device 102 associated with a requestor 102A. The requestor-computing device 102 may receive multimedia content 402A and at least one annotation 402B of the multimedia content 402A from the user-computing device 104. The user-computing device 104 may be associated with a user 104A. An exemplary graphical user interface (GUI) to present the multimedia content 402A to the requestor 102A has been described later in FIG. 5A.

The user 104A may have appended the annotation 402B with the multimedia content 402A. The annotation 402B may correspond to a description of a subject and/or an action in the multimedia content 402A. However, the annotation 402B may not correspond to a specific temporal location in the multimedia content 402A, which is associated with a specific subject and/or a specific action in the multimedia content 402A. Therefore, the requestor 102A may utilize the requestor-computing device 102 to transmit the request 404 to the application server 106 for the identification of the plurality of concepts in the multimedia content 402A. The request 404 comprises the multimedia content 402A and the at least one annotation 402B.

After the reception of the request 404, the application server 106 may process the multimedia content 402A for the identification of the set of frames 406 in the multimedia content 402A. The application server 106 may be further configured to extract the plurality of keywords 408 from the at least one annotation 402B. Thereafter, the application server 106 may extract the plurality of features 410 from the multimedia content 402A based on the plurality of keywords 408. The plurality of features 410 may comprise the one or more feature points associated with the one or more faces, the one or more feature points associated with the one or more objects, and the one or more feature points associated with the one or more actions in the multimedia content 402A. The application server 106 may utilize one or more image processing algorithms on the multimedia content 402A for the extraction of the plurality of features 410. Examples of the one or more image processing algorithms may include, but are not limited to, face detection, shot boundary detection, shot tracking, face tracking, bounding box tracking, and activity detection. In an embodiment, the application server 106 may further utilize the non-parametric method known in the art to perform the statistical analysis for the extraction of the plurality of features 410. Thereafter, the application server 106 may utilize the one or more classifiers 412 for the identification of the plurality of concepts 414 from the set of frames 406 of the multimedia content 402A. In an embodiment, the one or more classifiers 412 may identify the plurality of concepts 414 based on the plurality of features 410. In an embodiment, the plurality of concepts 414 may comprise the one or more faces (i.e., an instance of an entity), the one or more objects, the one or more actions, the one or more shot boundaries, and the one or more subset of frames with similar faces, actions, and/or objects (i.e., an instance of a scene) from the set of frames 406 of the multimedia content 402A.

For the identification of the one or more faces and the one or more objects (i.e., the subjects) the application server 106 may be configured to segment each of the set of frames 406 by utilizing one or more segmentation techniques, such as dense scale invariant feature transform (DSIFT), known in the art. Thereafter, the application server 106 may utilize an encoding technique, such as fisher vector encoding, for the identification of the plurality of features 410 from the segmented set of frames 406. The fisher vector encoding utilizes the one or more classifiers 412, such as a GMM model, during the training phase. Thereafter, the application server 106 may utilize a video pooling technique on the output of fisher vector encoding to aggregate the plurality of features extracted from the set of frames 406. Further, the application server 106 may utilize a PCA whitening technique on the aggregated plurality of features to identify the plurality of concepts 414, i.e., the one or more faces and the one or more objects from the multimedia content 402A.

For the identification of the one or more actions, the application server 106 may be configured to extrapolate one or more bounding boxes. The one or more bounding boxes may be determined by performing one or more image processing algorithms, such as face tracking, bounding box tracking, on the set of frames 406. Thereafter, the application server 106 may utilize dense trajectory algorithms to capture local motion information (i.e., one or more feature points that are utilized to detect and/or track an action) in the set of frames 406. Thereafter, the application server 106 may utilize fisher vector encoding and PCA whitening technique on the captured local motion information for the recognition of the one or more actions (i.e., the plurality of concepts 414) in the multimedia content 402A.

Once the plurality of concepts 414 is identified, the application server 106 may identify the temporal locations 416 associated with each of the plurality of concepts 414. The application server 106 further uses the temporal locations 416 to interrelate the plurality of concepts 414. For example, the concepts (i.e., entities, objects, actions, and/or scenes) with similar temporal locations 416 are interrelated by the application server 106. Thereafter, the application server 106 identifies an interrelated concept from the plurality of interrelated concepts that represents the at least one annotation 402B. In an embodiment, the application server 106 may utilize one or more natural language processing algorithms (such as semantic analysis) to identify the interrelated concept that represents the at least one annotation 402B.

Further, the application server 106 may annotate the multimedia content 402A with the annotation 402B at the temporal location associated with the identified interrelated concept. After annotation, the application server 106 may transmit the annotated multimedia content 418 to the requestor-computing device 102 and the database server 108, over the communication network 110. An exemplary graphical user interface to present the annotated multimedia content to the requestor has been described later in FIG. 5B.

A person having ordinary skill in the art will understand that the abovementioned exemplary scenario is for illustrative purpose and should not be construed to limit the scope of the disclosure.

FIGS. 5A and 5B are block diagrams that illustrate graphical user interface for presenting multimedia content to a requestor, in accordance with at least one embodiment. FIGS. 5A and 5B are explained in conjunction with FIGS. 1-4.

With reference to FIG. 5A, there is shown a graphical user interface 500A that comprises a first display area 502 and a second display area 504. The first display area 502 displays the multimedia content 506A to the requestor 104A. In an embodiment, the first display area 502 may contain command buttons such as, play, rewind, forward, and pause, to control playback of the multimedia content 506A. The first display area 502 may further comprise a navigation bar that enables the requestor to navigate through the multimedia content 506A. In an embodiment, during the playback of the multimedia content 506A, the first display area 502 may display the played duration (e.g., “00:01:23”) of the multimedia content 506A. The second display area 504 displays the annotation 506B appended with the multimedia content 506A by the user 102A.

With reference to FIG. 5B, there is shown a graphical user interface 500B that comprises the first display area 502 and the second display area 504. The first display area 502 displays the annotated multimedia content 508A to the requestor 102A. In an embodiment, the first display area 502 may contain command buttons such as, play, rewind, forward, and pause, to control playback of the annotated multimedia content 508A. The first display area 502 may further comprise a navigation bar that enables the requestor to navigate through the annotated multimedia content 508A. In an embodiment, during the playback of the annotated multimedia content 508A, the first display area 502 may display the played duration (e.g., “00:15:57”) of the annotated multimedia content 508A. Further, the navigation bar may display temporal locations that are associated with the annotation 508B (e.g., “A1” and “A2”). The second display area 504 displays the annotation 508B (e.g., “A1” and “A2”) after syntactic analysis and the determination of temporal location of the corresponding concept in the annotated multimedia content 508A.

The disclosed embodiments encompass numerous advantages. The disclosure provides a method for multimedia processing to identify concepts in multimedia content. The disclosed method helps in identifying and localizing a plurality of concepts in multimedia content and further learns classification models for each of the plurality of concepts. The method further jointly models the plurality of concepts from multiple modalities in a unified framework with one or more pre-defined constraints. Further, the disclosed method provides an automatic and robust means for annotating specific segments of the multimedia content with concept specific labels/tags.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an I/O interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for multimedia processing to identify concepts in multimedia content. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person having ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for multimedia processing to identify concepts in multimedia content, the method comprising:
receiving, by a content extracting processor at a computing device, the multimedia content and at least one annotation of the multimedia content from another computing device, wherein the received at least one annotation includes a plurality of keywords that is representative of at least a plurality of concepts in the received multimedia content;
extracting, by a feature extracting processor at the computing device, a plurality of features from the received multimedia content by performing a statistical analysis of the multimedia content based on the plurality of keywords in the at least one annotation; and
identifying, by a concept identifying processor at the computing device, the plurality of concepts in a set of frames of the multimedia content by use of one or more classifiers, wherein the one or more classifiers are trained based on at least the extracted plurality of features.

2. The method of claim 1, wherein the multimedia content corresponds to at least one of video content, audio content, and a moving slideshow.

3. The method of claim 1, wherein the plurality of concepts includes at least two of an entity, an object, an action, and a scene, wherein a concept that corresponds to the plurality of concepts is interrelated with the remaining plurality of concepts.

4. The method of claim 1, wherein the plurality of features are extracted from the multimedia content based on at least the plurality of concepts.

5. The method of claim 1, wherein the one or more classifiers are further trained, by the processor, based on one or more pre-defined constraints.

6. The method of claim 1 further comprising determining, by a processor, a temporal location of each of the identified plurality of concepts in the multimedia content based on the set of frames associated with each of the identified plurality of concepts.

7. The method of claim 6 further comprising annotating, by the processor, the multimedia content based on at least the identified plurality of concepts and a temporal location associated with each of the identified plurality of concepts.

8. The method of claim 1, wherein the one or more classifiers correspond to one or more of a Support Vector Machine (SVM), a Nonparametric Bayes Model, a Stacked Indian Buffet Process (SIBP), a Latent Variable Model, a Gaussian Mixture Model (GMM), a Principal Component Analysis (PCA), a Dirichlet Process Mixture Model, and/or a Multi-instance Multi-label (MIML).

9. A system for multimedia processing to identify concepts in multimedia content, the system comprising:
a content extracting processor at a computing device configured to:
receive the multimedia content and at least one annotation of the multimedia content from a another computing device, wherein the received at least one annotation includes a plurality of keywords that is representative of at least a plurality of concepts in the received multimedia content;
a feature extracting processor at the computing device configured to:
extract a plurality of features from the received multimedia content by performing a statistical analysis of the multimedia content based on the plurality of keywords in the at least one annotation; and
a concept identifying processor at the computing device configured to:
identify the plurality of concepts in a set of frames of the multimedia content by use of one or more classifiers, wherein the one or more classifiers are trained based on at least the extracted plurality of features.

10. The system of claim 9, wherein the multimedia content corresponds to at least one of a video content, an audio content, and a moving slideshow.

11. The system of claim 9, wherein the plurality of concepts includes at least two of an entity, an object, an action, and a scene, wherein a concept that corresponds to the plurality of concepts is interrelated with the remaining plurality of concepts.

12. The system of claim 9, wherein the plurality of features are extracted from the multimedia content based on at least the plurality of concepts.

13. The system of claim 9, wherein the one or more classifiers are further trained, by the processor, based on one or more pre-defined constraints.

14. The system of claim 9, wherein a processor is configured to determine a temporal location of each of the identified plurality of concepts in the multimedia content based on the set of frames associated with each of the identified plurality of concepts.

15. The system of claim 14, wherein the processor is further configured to annotate the multimedia content based on the identified plurality of concepts and a temporal location associated with each of the identified plurality of concepts.

16. The system of claim 9, wherein the one or more classifiers correspond to one or more of a Support Vector Machine (SVM), a Nonparametric Bayes Model, a Stacked Indian Buffet Process (SIBP), a Latent Variable Model, a Gaussian Mixture Model (GMM), a Principal Component Analysis (PCA), a Dirichlet Process Mixture Model, and/or a Multi-instance Multi-label (MIML).

17. A computer program product for use with a computer, said computer program product comprising a non-transitory computer readable medium, wherein the non-transitory computer readable medium stores a computer program code for multimedia processing to identify concepts in multimedia content, wherein the computer program code is executable by one or more processors in a server to:
receiving the multimedia content and at least one annotation of the multimedia content from a another computing device, wherein the received at least one annotation includes a plurality of keywords that is representative of at least a plurality of concepts in the received multimedia content;
extracting a plurality of features from the received multimedia content by performing a statistical analysis of the multimedia content based on the plurality of keywords in the received at least one annotation; and
identifying the plurality of concepts in a set of frames of the multimedia content by use of one or more classifiers, wherein the one or more classifiers are trained based on at least the extracted plurality of features.
